(19) United States
(12) Patent Application Publication
(10) Pub. No.: US 2025/0284462 A1
(43) Pub. Date: Sep. 11, 2025

(54) REGULATED CANONICAL RANDOM NUMBER GENERATION

(71) Applicant: QUALCOMM Incorporated, San Diego, CA (US)

(72) Inventor: Remi GERAUD-STEWART, Mantes-la-Jolie (FR)

(21) Appl. No.: 18/597,690

(22) Filed: Mar. 6, 2024

(51) Int. Cl. G06F 7/58

(52) U.S. Cl. CPC G06F 7/582

(57) ABSTRACT

Systems and techniques are disclosed for generating canonical random number information. For example, a device can obtain first canonical random number information; store the first canonical random number information in a storage medium of a device based on a regulation parameter, wherein the regulation parameter is based on generation times of the first canonical random number information and at least second canonical random number information preceding the first canonical random number information; and output, based on an expiration of a duration defined by the regulation parameter, canonical random number information from the storage medium for processing by one or more cryptographic operations or machine learning operations.

### FIELD

The present disclosure generally relates to random number generation. For example, aspects of the present disclosure relate to systems and techniques for regulated canonical random number generation.

### BACKGROUND

Random numbers can be used for various purposes. For instance, computing devices often employ various techniques to protect data by performing security measures that are based on random number generation. Random numbers can be important as they provide a level of unpredictability that can ensure the security of certain security mechanisms, such as cryptographic algorithms. As an example, data may be subjected to encryption and decryption techniques in a variety of scenarios, such as writing data to a storage device, reading data from a storage device, writing data to or reading data from a memory device, encrypting and decrypting blocks and/or volumes of data, encrypting and decrypting digital content, performing inline cryptographic operations, etc. Such encryption and decryption operations are often performed, at least in part, using a security information asset, such as a cryptographic key, a derived cryptographic key, digital signatures, other cryptographic primitives, etc. Security information assets can be based on random numbers, such as cryptographic keys (e.g., encryption keys), digital signatures, etc.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary presents certain concepts relating to one or more aspects relating to the mechanisms disclosed herein in a simplified form to precede the detailed description presented below.

Systems and techniques are described herein for generating canonical random numbers with a regulator. According to aspects described herein, devices that generate canonical random numbers can reduce deviation of the generation of the canonical random numbers and improve user experience, development of features using canonical random numbers, and testing of features using canonical random numbers.

According to at least one example, a method for generating canonical random number information is provided. The method includes: obtaining first canonical random number information; storing the first canonical random number information in a storage medium of a device based on a regulation parameter, wherein the regulation parameter is based on a generation time of the first canonical random number information and at least second canonical random number information preceding the first canonical random number information; and outputting, based on an expiration of a duration defined by the regulation parameter, third canonical random number information from the storage medium for processing by a cryptographic operation or a machine learning operation.

In another example, an apparatus for generating canonical random number information is provided that includes a storage (e.g., a memory configured to store data, such as virtual content data, one or more images, etc.) and at least one processor (e.g., implemented in circuitry) coupled to the memory and configured to execute instructions and, in conjunction with various components (e.g., a network interface, a display, an output device, etc.), cause the apparatus to: obtain first canonical random number information; store the first canonical random number information in a storage medium of a device based on a regulation parameter, wherein the regulation parameter is based on a generation time of the first canonical random number information and at least second canonical random number information preceding the first canonical random number information; and output, based on an expiration of a duration defined by the regulation parameter, third canonical random number information from the storage medium for processing by a cryptographic operation or a machine learning operation.

In another example, an apparatus for generating canonical random number information is provided that includes: means for obtaining first canonical random number information; means for storing the first canonical random number information in a storage medium of a device based on a regulation parameter, wherein the regulation parameter is based on a generation time of the first canonical random number information and at least second canonical random number information preceding the first canonical random number information; and means for outputting, based on an expiration of a duration defined by the regulation parameter, third canonical random number information from the storage medium for processing by a cryptographic operation or a machine learning operation.

A non-transitory computer-readable storage medium is provided that includes instructions stored thereon which, when executed by a processor, causes the processor to: obtain first canonical random number information; store the first canonical random number information in a storage medium of a device based on a regulation parameter, wherein the regulation parameter is based on a generation time of the first canonical random number information and at least second canonical random number information preceding the first canonical random number information; and output, based on an expiration of a duration defined by the regulation parameter, third canonical random number information from the storage medium for processing by a cryptographic operation or a machine learning operation.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. It is intended that aspects described herein may be practiced in a wide variety of devices, components, systems, distributed arrangements, and/or end-user devices of varying size, shape, and constitution.

Other objects and advantages associated with the aspects disclosed herein will be apparent to those skilled in the art based on the accompanying drawings and detailed description.

### BRIEF DESCRIPTION OF THE DRAWINGS

Examples of various implementations are described in detail below with reference to the following figures:

FIG. 1 is a block diagram illustrating certain components of a computing device, in accordance with some aspects of the disclosure;

FIG. 2 is a block diagram of a conventional random number generator that provides prime numbers with a high deviation device, in accordance with some aspects of the disclosure;

FIG. 3 is a conceptual diagram of a canonical random number generator for providing canonical random numbers, in accordance with some aspects of the disclosure;

FIG. 4A is a graph that illustrates deviation of prime numbers generated by a conventional random number generator;

FIG. 4B is a graph that illustrates deviation of prime numbers generated by a canonical random number generator in accordance with some aspects of the disclosure;

FIG. 4C is a graph that illustrates deviation of prime numbers generated by a canonical random number generator in the same system at FIG. 4A with a different threshold in accordance with some aspects of the disclosure

FIG. 5 is a flow diagram illustrating another example of a process for wireless communication, in accordance with aspects of the present disclosure; and

FIG. 6 is a diagram illustrating an example of a system for implementing certain aspects of the present technology.

### DETAILED DESCRIPTION

Certain aspects and embodiments of this disclosure are provided below. Some of these aspects and embodiments may be applied independently and some of them may be applied in combination as would be apparent to those of skill in the art. In the following description, for the purposes of explanation, specific details are set forth in order to provide a thorough understanding of embodiments of the application. However, it will be apparent that various embodiments may be practiced without these specific details. The figures and description are not intended to be restrictive.

The ensuing description provides example embodiments only, and is not intended to limit the scope, applicability, or configuration of the disclosure. Rather, the ensuing description of the exemplary embodiments will provide those skilled in the art with an enabling description for implementing an exemplary embodiment. It should be understood that various changes may be made in the function and arrangement of elements without departing from the spirit and scope of the application as set forth in the appended claims.

Random numbers are important for many computing devices. In some cases, computing devices can protect data by performing security measures that are based on random number generation. Random numbers can provide unpredictability, which can provide security for various security algorithms, including cryptographic algorithms. As an example, data may be subjected to encryption and decryption techniques in a variety of scenarios, such as writing data to a storage device, reading data from a storage device, writing data to or reading data from a memory device, encrypting and decrypting blocks and/or volumes of data, encrypting and decrypting digital content, performing inline cryptographic operations, etc. Such encryption and decryption operations are often performed, at least in part, using a security information asset, such as a cryptographic key, a derived cryptographic key, digital signatures, other cryptographic primitives, etc.

Encryption plays a crucial role in various areas of technology, such as in securing communications in wireless communication networks such as 4G and 5G networks. 5G networks encrypt user data and control data to protect data integrity, confidentiality, and ensure secure communication between devices and the network infrastructure. The encryption is applied in different contexts, for example symmetric and asymmetric encryption, to protect different assets with different techniques. For example, 5G encryption user data to ensure that any transmitted user data transmitted between devices and the network is confidential and cannot be intercepted by unauthorized entities.

In some cases, the physical layer in 5G, which is also referred to as the radio interface, may encrypt the user data using an Advanced Encryption Standard (AES) algorithm. AES is a symmetric encryption algorithm that provides a high level of security. The physical layer may also be encrypted with asymmetric encryption such as Rivest-Shamir-Adleman (RSA) to realize secure communication. The radio interface is encrypted to prevent eavesdropping, unauthorized access, and provide data integrity to ensure that transmitted data remains unaltered.

Various systems (e.g., wireless communication systems, computing systems, networking systems, etc.) may also use secure key exchange mechanisms to establish cryptographic keys between devices and different network elements. Computing devices may also provide key derivation functions to generate cryptographic keys and key rotation mechanisms to ensure keys are easily predictable, susceptible to attacks, and mitigate network threats. Encryption is also used for authentication and authorization of users and devices to protect against impersonation attacks by verifying the authenticity of communication partners and denying malicious actors access to the network. In some cases, a device may generate asymmetric encryption keys (e.g., public and private keys using an RSA algorithm) and provide the public key to a communicating party.

Security information assets can be based on random numbers, such as cryptographic keys (e.g., encryption keys), digital signatures, etc. For example, the generation of the keys may be based on a random number generator (RNG) is based on entropy within the hardware of the device to generate unpredictable and statistically random numbers. Entropy is a measure of uncertainty or randomness in a system and can be provided based on unpredictable physical processes such as electronic noise, radioactive decay, or atmospheric noise. There is a finite amount of entropy that is available from the entropy sources (e.g., electronic noise, radioactive decay, or atmospheric noise) and once the available entropy is exhausted, the RNG cannot produce additional random numbers without additional entropy input, which is often referred to as entropy exhaustion.

To maintain the quality of randomness and security, entropy may be periodically replenished because, without a continuous input of fresh entropy, the RNG may become predictable. When the RNG becomes predictable, the output random numbers may be susceptible to exploitation by adversaries who may attempt to predict or control the sequence of generated numbers. In addition, not all random numbers from an RNG may be used. Various numbers have properties that provide more security when using these numbers for different purposes. For example, strong prime numbers possess certain properties that are suitable for cryptographic applications.

Canonical random number information is used in encryption and other advanced computations. Canonical random number information includes random numbers or other random mathematical constructs (e.g., matrices) that have specific properties that make canonical random numbers important. Non-limiting examples of canonical random number information include strong prime numbers, random invertible matrices, and random quadratic residues.

Strong prime numbers may be used for many encryption applications. For example, RSA encryption uses a pair of random numbers that are prime numbers, and one of the random numbers is a strong prime. A strong prime number has a large size which makes encryption keys generated based on the strong prime number resistant to factorization attacks. Strong prime numbers are also chosen to have specific mathematical forms, such as being within a tolerance range of an exponential value (e.g., n², etc.). Strong prime numbers are also selected to minimize the likelihood of having small factors, which can be exploited in certain attacks. Strong prime numbers make attacks computationally infeasible to factorize the product of two large prime numbers.

Random quadratic residues can also be used for cryptographic applications. A random quadratic residue is a random, non-zero integer that is the square of another integer modulo given some modulus. For instance, for a modulus n, a quadratic residue x satisfies x²=a (mod n) for some integer a. For example, the security in RSA encryption is premised on the difficulty of factoring large composite numbers into their prime factors. Encryption algorithms such as RSA use random quadratic residues to generation of cryptographic keys and the modulo square of a random integer serves as a quadratic residue. The quadratic residue property enhances the security of the cryptographic system by introducing mathematical complexity and causes deriving (e.g., attacking) the original factors computationally challenging. Random quadratic residues ensure that cryptographic keys are resistant to attacks based on number theory and factorization algorithms.

Random invertible matrices is a square matrix with entries chosen randomly from a specified distribution such that the matrix has a nonzero determinant and possesses an inverse. Random invertible matrices are versatile canonical random number information that is used in diverse applications including cryptography, machine learning, and other linear algebra and numerical analysis applications. For example, random invertible matrices are employed in cryptographic protocols such as block ciphers or public-key encryption systems and make deciphering encrypted information without the knowledge of the corresponding inverse matrices impracticable. Random invertible matrices are also employed in machine learning and statistical modeling to decorrelate and normalize data and improve performance in algorithms that rely on linear transformations. In addition, random invertible matrices can be used in dimensionality reduction techniques to transform features while retaining essential information and removing redundant or correlated components. The randomization aspect of random invertible matrices is useful in synthetic datasets for testing and validating machine learning models. Random invertible matrices introduce diversity in the data to assess the robustness and generalization capabilities of algorithms under different scenarios.

In some cases, the cryptographic key generation is limited due to the amount of entropy available for generating random numbers, and further limited because not every random number is a strong prime number or even a prime number. The random nature of cryptographic key generation causes the generation of a strong prime numbers to have a high deviation. In some cases, the generation of the strong prime can be relatively quick. However, in other cases, the generation of the strong prime is relatively long. The deviation of generating a strong prime can frustrate user experience as well as development, debugging, and testing of features that use a random prime number. For example, some processes can time out if the strong prime is not provided within a time period. As an example, while setting up a VPN by an application executing on a device, the application requests a strong prime number from an RNG and, in the event of a long duration until the strong prime number, the connection setup mechanism in the application may time out. In other cases, the strong prime number is provided in a suitable time, which can lead to user and developer experiences that are frustrating. The lack of predictability of the strong prime number can have adverse effects, for example, by not adequately testing features related to strong prime numbers.

Systems, apparatuses, processes (also referred to as methods), and computer-readable media (collectively referred to herein as “systems and techniques”) are described herein for generating canonical random numbers. According to aspects described herein, a regulator can be introduced into a random number generator (RNG) that, when a canonical random number is determined to be early, is stored. When a canonical random number is late, the regulator can retrieve the stored canonical random numbers to fill in. The regulator changes the distribution of canonical random numbers from a Gaussian distribution with high standard deviation to an exponential distribution with lower standard deviation. For example, the regulator reduces the deviation of the canonical random numbers in edge cases and can improve user and development experience.

In some aspects, the regulator can include a fixed threshold that causes early canonical random numbers within the fixed threshold to be stored and then fill in for late canonical random numbers. In some aspects, the regulator can include a dynamic threshold that changes based on the quantity of canonical random numbers that are stored in the store. In either case, the threshold design should be experimentally determined based on the device to reduce deviation in delays between canonical random numbers.

The systems and techniques reduce the extreme delays that can be experienced and provide a minimum delay, but reduce extreme cases based on regulating the output. The systems and techniques can be used to generate canonical random number information that can be used in various cryptographic and/or machine learning functions. For example, the canonical random number information can be random strong prime numbers, random quadratic residues, and random invertible matrices. The use, development, debugging, and testing of features that use canonical random number information can be improved by reducing the deviation and providing a predictable delay between requesting and receiving the canonical random number information.

Additional aspects of the present disclosure are described in more detail below.

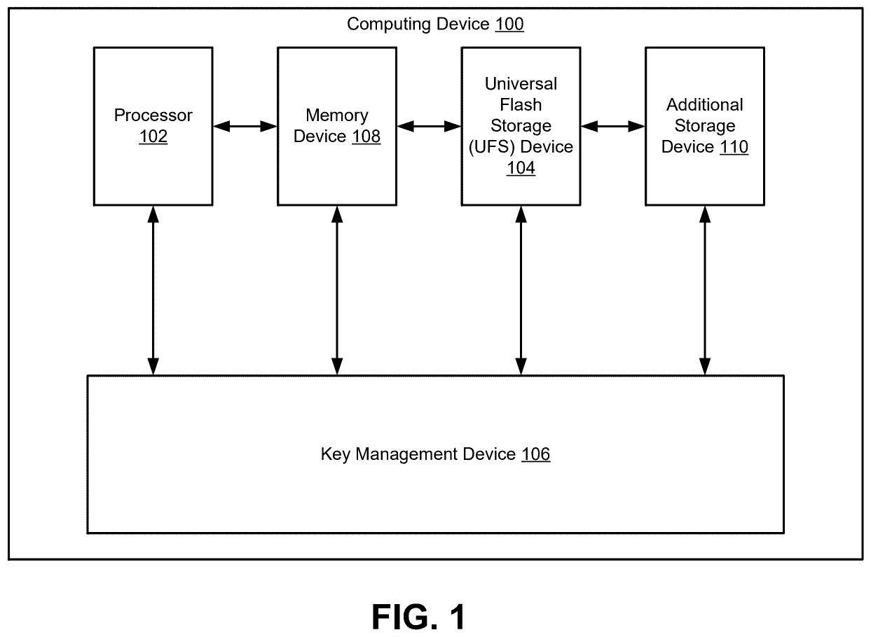

FIG. 1 is a block diagram illustrating an example of a computing device 100. As shown, the computing device 100 includes a processor 102, a universal flash storage (UFS) device 104, a memory device 108, an additional storage device 110, and a number generation system 106. Each of these components is described below.

The computing device 100 is any device, portion of a device, or any set of devices capable of electronically processing instructions and may include, but is not limited to, any of the following: one or more processors (e.g. components that include integrated circuitry, memory, input and output device(s) (not shown), non-volatile storage hardware, one or more physical interfaces, any number of other hardware components (not shown), and/or any combination thereof. Examples of computing devices include, but are not limited to, a mobile device (e.g., laptop computer, smart phone, personal digital assistant, tablet computer, automobile computing system, and/or any other mobile computing device), an Internet of Things (IoT) device, a server (e.g., a blade-server in a blade-server chassis, a rack server in a rack, etc.), a desktop computer, a storage device (e.g., a disk drive array, a fibre channel storage device, an Internet Small Computer Systems Interface (iSCSI) storage device, a tape storage device, a flash storage array, a network attached storage device, etc.), a network device (e.g., switch, router, multi-layer switch, etc.), a wearable device (e.g., a network-connected watch or smartwatch, or other wearable device), a robotic device, a smart television, a smart appliance, an extended reality (XR) device (e.g., augmented reality, virtual reality, etc.), any device that includes one or more SoCs, and/or any other type of computing device with the aforementioned requirements. In one or more examples, any or all of the aforementioned examples may be combined to create a system of such devices, which may collectively be referred to as a computing device. Other types of computing devices may be used without departing from the scope of examples described herein.

In some examples, the processor 102 is any component that includes circuitry for executing instructions (e.g., of a computer program). As an example, such circuitry may be integrated circuitry implemented, at least in part, using transistors implementing such components as arithmetic logic units, control units, logic gates, registers, first-in, first-out (FIFO) buffers, data and control buffers, etc. In some examples, the processor may include additional components, such as, for example, cache memory. In some examples, a processor retrieves and decodes instructions, which are then executed. Execution of instructions may include operating on data, which may include reading and/or writing data. In some examples, the instructions and data used by a processor are stored in the memory (e.g., memory device 108) of the computing device 100. A processor may perform various operations for executing software, such as operating systems, applications, etc. The processor 102 may cause data to be written from memory to storage of the computing device 100 and/or cause data to be read from storage via the memory. Examples of processors include, but are not limited to, central processing units (CPUs), graphics processing units (GPUs), neural processing units, tensor processing units, display processing units, digital signal processors (DSPs), finite state machines, etc. The processor 102 may be operatively connected to the memory device 108, any storage (e.g., UFS device 104, additional storage device 110) of the computing device 100, and/or to the number generation system 106. Although FIG. 1 shows the computing device 100 having a single processor 102, the computing device may include any number of processors without departing from the scope of examples described herein.

In some examples, the computing device 100 includes a UFS device 104. In some examples, the UFS device 104 is a flash storage device conforming to the UFS specification. The UFS device 104 may be used for storing data of any type. Data may be written to and/or read from the UFS device 104. As an example, the UFS device may store operating system images, software images, application data, etc. The UFS device 104 may store any other type of data without departing from the scope of examples described herein. In some examples, the UFS device 104 includes NAND flash storage. The UFS device 104 may use any other type of storage technology without departing from the scope of examples described herein. In some examples, the UFS device 104 is capable of data rates that are relatively faster than other storage devices (e.g., additional storage device 110) of the computing device 100. The UFS device 104 may be operatively connected to the processor 102, the memory device 108 and/or the additional storage device 110. Although FIG. 1 shows the computing device 100 having a single UFS device 104, the computing device may include any number of UFS devices without departing from the scope of examples described herein. Additionally, although FIG. 1 shows the UFS device 104, the computing device 100 may include any other type of flash storage device without departing from the scope of examples described herein.

In some examples, the computing device 100 includes an additional storage device 110. In some examples, the additional storage device is a non-volatile storage device. The additional storage device 110 may, for example, be a persistent memory device. In some examples, the additional storage device 110 may be computer storage of any type. Examples of type of computer storage include, but are not limited to, hard disk drives, solid state drives, flash storage, tape drives, removable disk drives, Universal Serial Bus (USB) storage devices, secure digital (SD) cards, optical storage devices, read-only memory devices, etc. Although FIG. 1 shows the additional storage device 110 as part of the computing device 100, the additional storage device may be separate from and operatively connected to the computing device 100 (e.g., an external drive array, cloud storage, etc.). In some examples, the additional storage device 110 operates at a data rate that is relatively slower than the UFS device 104. In some examples, the additional storage device 110 is also a UFS storage device. In some examples, the additional storage device 110 is operatively connected to the processor 102, the UFS device 104, the key management device, and/or the memory device 108. Although FIG. 1 shows the computing device 100 having a single additional storage device 110, the computing device 100 may have any number of additional storage devices without departing from the scope of examples described herein.

In some examples, the computing device 100 includes a memory device 108. The memory device may be any type of computer memory. In some examples, the memory device 108 is a volatile storage device. As an example, the memory device 108 may be random access memory (RAM). In one or more examples, data stored in the memory device 108 is located at memory addresses, and is thus accessible to the processor 102 and/or the number generation system 106 using the memory addresses. Similarly, the processor 102 and/or number generation system 106 (or components therein) may write data to and/or read data from the memory device 108 using the memory addresses. The memory device 108 may be used to store any type of data, such as, for example, computer programs, the results of computations, etc. In some examples, the memory device 108 is operatively connected to the processor 102, the UFS device 104, the additional storage device 110, and the number generation system 106. Although FIG. 1 shows the computing device 100 having a single memory device 108, the computing device 100 may have any number of memory devices without departing from the scope of examples described herein.

In some examples, the computing device 100 includes a number generation system 106. In some examples, the number generation system 106 is any hardware, software, firmware, or combination thereof that is configured to perform various actions and operations to perform random number operations. As an example, the number generation system 106 may be used to regulate the output of random numbers generated by a random number generator (RNG) for downstream processing by consumer of the random number. In some examples, the number generation system 106 is operatively connected to the processor 102, the memory device 108, the UFS device 104, and/or the additional storage device 110. In some examples, the output of the entropy-encoding algorithm may be stored in one or more of such devices, and the storage space required may be less that the storage space required to store a full matrix that is to be used for performing cryptographic operations.

While FIG. 1 shows a certain number of components in a particular configuration, one of ordinary skill in the art will appreciate that the computing device 100 may include more components or fewer components, and/or components arranged in any number of alternate configurations without departing from the scope of examples described herein. Additionally, although not shown in FIG. 1, one of ordinary skill in the art will appreciate that the computing device 100 may execute any amount or type of software or firmware (e.g., bootloaders, operating systems, hypervisors, virtual machines, computer applications, mobile device apps, etc.). Accordingly, examples disclosed herein should not be limited to the configuration of components shown in FIG. 1.

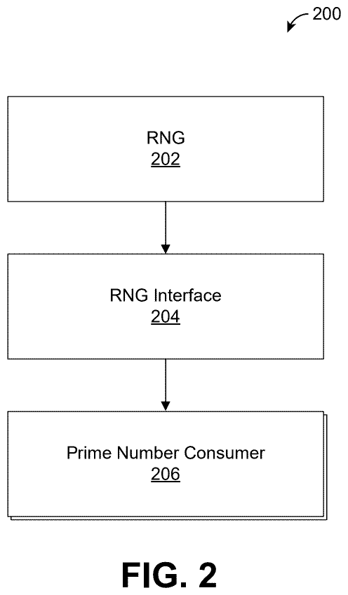

FIG. 2 is a block diagram of a prime number generation system 200 that provides prime numbers with a high deviation. The prime number generation system 200 comprises an RNG 202, an RNG interface 204, and at least one prime number consumer 206. The prime number consumer 206 can include various software applications executing on the device, such as a VPN application, a cryptographic library, a messaging application, and so forth. The prime number consumer 206 can also include system-level devices or components, such as a wireless communication device or an API associated with a wireless communication protocol. For example, the prime number consumer 206 may be a cryptographic library that requests random primes to generate encryption keys, such as a secure messaging application that calls a cryptographic library in connection with generating a secure communication channel.

The RNG interface 204 is configured to receive requests from hardware or software engines to interface with the RNG 202. For example, the RNG interface 204 may be integrated into an API or other system-level functionality (e.g., Keymaster, etc.) that provides an interface between the prime number consumer 206 and the RNG 202. The prime number consumer 206 may be a cryptographic library and may request a strong prime number from the RNG interface 204.

In some aspects, the RNG interface 204 may filter random numbers based on the request. For example, the RNG interface 204 may receive a request from the prime number consumer 206 for a prime number, and, in response, the RNG interface 204 provides the next random number from the RNG 202 that is a prime number. In another example, the RNG interface 204 may receive a request from the prime number consumer 206 for a strong prime number and, in response, the RNG interface 204 provides the next random number from the RNG 202 that is a strong prime number. In this case, the RNG interface 204 filters numbers received from the RNG 202 that are not strong prime numbers and a delay can be introduced between the request and when the RNG interface 204 provides the next strong prime number.

In some aspect, strong prime numbers have specific qualities and the RNG interface 204 must wait for a random number that includes the qualities of the strong prime. A strong prime number possesses properties that are suitable for cryptographic applications and enhance the security of cryptographic algorithms, such as RSA encryption. For example, RSA encryption uses a pair of random prime numbers, and one of the random numbers is a strong prime. A strong prime number has a large size which makes encryption keys generated based on the strong prime number resistant to factorization attacks. Strong prime numbers are also chosen to have specific mathematical form, such as being within a tolerance range of an exponential value (e.g., n², etc.). Strong prime numbers are also selected to minimize the likelihood of having small factors, which can be exploited in certain attacks. Strong prime numbers cause attacks computationally infeasible to factorize the product of two large prime numbers.

However, the strong prime numbers generated by the prime number generation system 200 may have a high standard deviation of generation time between successive strong prime numbers (e.g., a time delay between two strong prime numbers). In some cases, the delay between requesting and receiving a strong prime number may be sufficient (e.g., within 1 second). However, edge cases may have the delay between requesting and receiving a strong prime number to be large (e.g., 7 seconds) due to the random nature of the numbers generated. This long delay can cause issues in the use of the application, which degrades the user experience. The long day can also frustrate the development and debugging of the application.

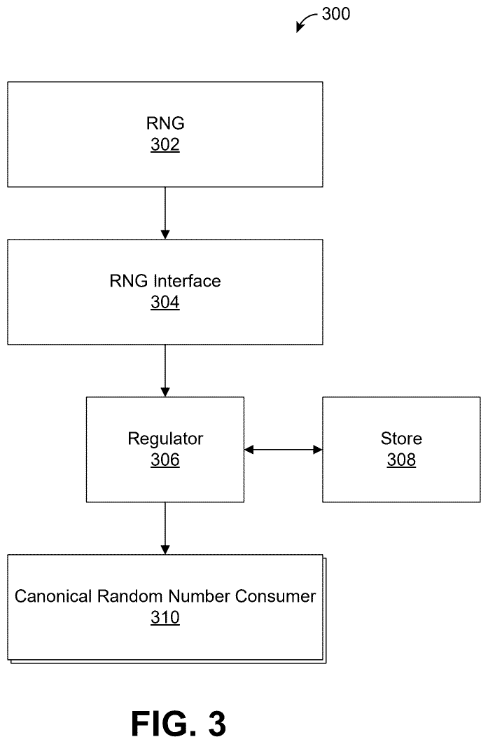

FIG. 3 is a conceptual diagram of a canonical random number generation system 300 for providing canonical random numbers in accordance with some aspects of the disclosure. The canonical random number generation system 300 can be used as the number generation system 106 of FIG. 1. The canonical random number generation system 300 includes an RNG 302, a canonical random number selector 304, a regulator 306, a store 308, and at least one canonical random number consumer 310. In some aspects, the canonical random number generation system 300 is configured to regulate the output of canonical random number information (e.g., random strong primes, random quadratic residues, and random invertible matrices) based on a regulation parameter.

In some aspects, the RNG 302 is configured to generate random numbers based on entropy and may implement the functions and structures described with respect to the RNG 202 of FIG. 2.

The canonical random number selector 304 is configured to receive the random numbers from the RNG 302, determine whether the random numbers correspond to canonical random numbers (e.g., strong primes, quadratic residues, invertible matrices, etc.), and output canonical random number information to the regulator 306 when available. For example, the canonical random number selector 304 is configured to determine whether the random number from the RNG 302 is a random strong prime number, a random quadratic residue, or can be converted into a random invertible matrix. For instance, a matrix (e.g., a matrix M of dimension n×n) is invertible if there exists another matrix of the same dimension (e.g., another matrix N of dimension n×n), such that MN=NM=I, where I is the identity matrix of the same order. The canonical random number selector 304 may also be configured to generate or transform canonical random numbers into a consumable form. For example, the canonical random number selector 304 is configured to generate a matrix or other numerical representation from the input random number.

The regulator 306 is configured to regulate canonical random number information output from the canonical random number selector 304 based on the regulation parameter and store the canonical random number information in the store 308. In some aspects, the regulation parameter can be defined as (or based on) a threshold u. For instance, the regulation parameter (e.g., the threshold u) can be based on a generation time of canonical random number information. For example, according to some aspects, the regulation parameter (e.g., the threshold u) may be in units of a number of cycles (e.g., 10⁴ cycles of a clock of a device include the canonical random number generation system 300, 700 ms, etc.), may be in units of time, or any other similar unit. In some aspects, the store 308 comprises a small storage space for canonical random number information and the regulator 306 is configured to identify early canonical random number information and store early canonical random number information to fill in for late canonical random number information in a data structure (e.g., a stack, a queue, a linked list, etc.) used to store the canonical random number information in the store 308. For example, the store 308 may be a stack that operates on a first-in first-out (FIFO) basis. The store may also be a primitive (e.g., an array of integers, etc.) or non-primitive (e.g., an object having references, primitive values, and other properties, etc.) When a duration between a previous canonical random number information and a current canonical random number information is less than the regulation parameter (e.g., the threshold u), the regulator 306 stores the current canonical random number information in the store 308. When the duration between the duration between a previous canonical random number information and a current canonical random number information is more than the regulation parameter (e.g., the threshold u), the regulator 306 is configured to pop the stack in the store 308 for canonical random number information.

In some aspects, Table 1 below illustrates pseudocode that can be implemented by the regulator 306. In the pseudocode, var is an implicit type at design time and is compiled into proper types at compilation. In this case, the store is an array of integers (e.g., List<int>, number [ ], etc.) that is provided to the function, a threshold is set to a fixed value (e.g., 700 ms as noted below), and a while loop is configured until a strong prime number is identified.

TABLE 1

```
function getStrongPrime(store) {
  var count = 0;
  var threshold = 700; // aka μ, assume 700 = 700ms
  while (true) {
    var random = Math.Random( );
    var isStrongPrime = checkIsStrongPrime(random);
    if (isStrongPrime && count < threshold) {
      store.push(random);
    } else if (isStrongPrime) {
      return random;
    } else if (count > threshold && store.length > 0) {
      return store.pop( );
    }
    count++;
  }
}
```

In this aspect, each iteration of the loop waits for a random number (e.g., random) to be generated (e.g., by the RNG 302) and checks whether the random number is a strong prime. If the random number is a strong prime number and a counter is less than the threshold, the random number is pushed on the store, the count increases, and the next loop iteration begins. If the random number is a strong prime number and the count is less than or equal to the threshold (implicit based on the previous logical statement), the random value is returned. If the count is greater than the threshold and there are values stored in the store, (e.g., store.length >0) then the first number in the store is popped from the stack and returned to the consumer (e.g., the canonical random number consumer 310).

The threshold u may be fixed, and the value of the threshold u should be neither too small (e.g., no regulation) nor too large (e.g., too much regulation). In some cases, the value of threshold u may be selected at design time and fixed. This value can be determined based on experimentation, testing, feedback, and other relevant user and developer metrics.

In some aspects, the regulator 306 or other system control may be configured to dynamically control threshold u based on an amount of canonical random number information stored in the store 308 to a storage threshold. For example, the regulator 306 may be configured to control the threshold u such that a stored quantity of canonical random number information stored in the store 308 is at a certain capacity (e.g., a median capacity, such as half capacity) for most of the time. In one illustrative aspect, when the store 308 becomes at least half full (or is greater or equal to any other storage threshold), the threshold u is lowered to empty the store 308. In another illustrative aspect, when the store 308 becomes at least half empty (or is less than or equal to any other storage threshold), the threshold u is increased to fill the store 308. An example of a storage ratio function based on different storage thresholds is shown in pseudocode illustrated in Table 2 below.

TABLE 2

```
function updateStorageThreshold(store, threshold) {
    let storeRatio = store.length/store.capacity;
  switch (storeRatio) {
    case storeRatio < 0.1:
      return threshold += 100;
    case storeRatio < 0.2:
      return threshold += 10;
    case storeRatio < 0.3:
      return threshold += 5;
    case storeRatio < 0.5:
      return threshold += 1;
    case storeRatio < 0.7:
      return threshold −= 1;
    case storeRatio < 0.8:
      return threshold −= 5;
    case storeRatio < 0.9:
      return threshold −= 10;
    case storeRatio <= 1.0:
      return threshold −= 100;
  }
}
```

In the aspect illustrated in Table 2, the storage ratio of the capacity of the storage (e.g., the list) is calculated and based on the storage ratio, the threshold u is increased or decreased at different rates. For example, when the storage ratio is between 30% and 49%, the threshold u is increased by 1 and when the storage ratio is between 50% and 69%, the threshold u is decreased by 1. However, when the storage ratio is between 91% and 100%, the threshold u is decreased by 100 to increase the number of canonical random numbers provided by the regulator. In this aspect, a hysteresis may also be implemented to smooth the changes to the threshold and account for changes within a window of time.

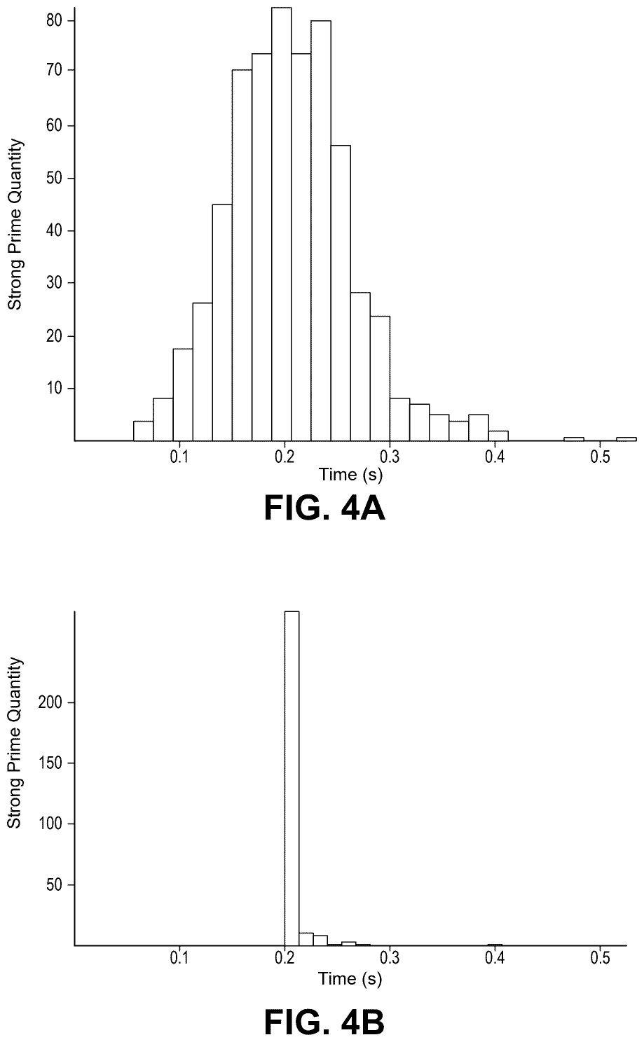

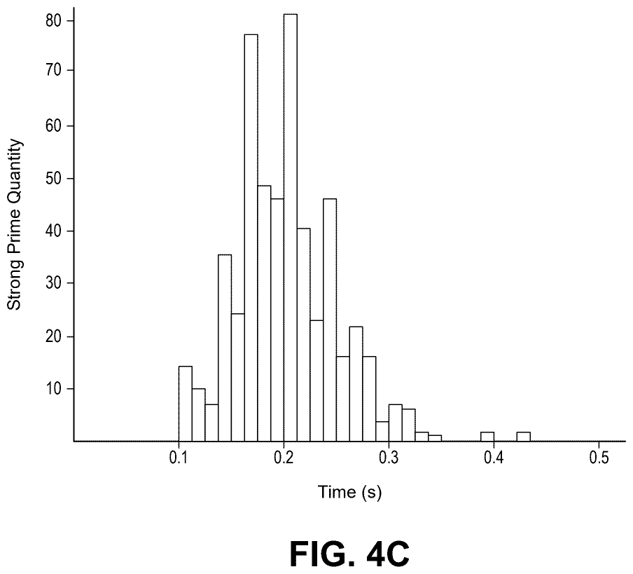

FIG. 4A is a graph that illustrates deviation of prime numbers generated by a conventional RNG of a system. For example, the graph in FIG. 4A illustrates the duration between consecutive random prime numbers during a testing period. In FIG. 4A, the minimum time of a strong prime number generation is 0.068 seconds, the maximum time is 0.587 seconds, and the mean time is 0.213 seconds. However, the graph in FIG. 4A has a Gaussian distribution, which corresponds to the Gaussian nature of entropy sources.

FIG. 4B is a graph that illustrates deviation of prime numbers generated by a canonical random number generation system in the same system in FIG. 4A in accordance with some aspects of the disclosure. In this case, the threshold u is experimentally determined to be 0.2 seconds and therefore no strong prime numbers can occur before 0.2 seconds. Therefore, the minimum time of a strong prime number generation is 0.200 seconds, the maximum time is 0.400 seconds, and the mean time is 0.213 seconds. While the mean time does not change, the distribution shown in FIG. 4B corresponds to an exponential distribution and the standard deviation is much smaller than the standard deviation in FIG. 4A.

FIG. 4C is a graph that illustrates deviation of prime numbers generated by a canonical random number generation system in the same system at FIG. 4A with a poorly chosen threshold u in accordance with some aspects of the disclosure. In this case, the threshold u is selected to be 0.1 seconds. As shown in FIG. 4C, the minimum time of a strong prime number generation is 0.100 seconds, the maximum time is 0.440 seconds, and the mean time is 0.22 seconds. However, the distribution shown in FIG. 4C shows a higher standard deviation based on the poorly chosen threshold u. The ability to reduce deviation therefore is premised on a good threshold u. In some aspects, the threshold u should be chosen based on the mean value identified in an uncontrolled example (e.g., as shown in FIG. 4A).

In some aspects, the regulator can be combined with a Fouque-Tibouchi prime generator. A Fouque-Tibouchi prime generator requires fewer random bits from the RNG and is inherently less susceptible to variations in RNG latency. The Fouque-Tibouchi prime generator also makes fewer calls to the primality testing subroutine, which is itself a source of variation and may consume further entropy and limit random number generation. with fewer random bits. To generate a prime p less than x, the Fouque-Tibouchi prime generator fixes a constant q∝x^{1-ε}, picks a uniformly random a<q coprime to q, and chooses p of the form a+t·q. For example, the pseudocode of a Fouque-Tibouchi prime generator is listed in Table 2 below.

```
TABLE 3
function FouqueTibouchiPrimeGenerator (q: int, a: int, x: int): prime {
  while (true) {
    select integer t at random in {0, 1, ..., (x-a)/q}
    var p = a + t * q
    if (isPrime(p)) {
      return p;
    }
  }
}
```

In this aspect, the value x is the bound for the sought-after prime number, the value q corresponds to x^{1-ε} for a fixed value epsilon that is chosen at design time, and the value a is an integer that is smaller than q and coprime with q. In some aspects, the q, a, and x parameters can be fixed. In some aspects, combining the Fouque-Tibouchi prime generator algorithm achieves further improves deviation because the input has better behavior.

In other aspects, a variant of the Fouque-Tibouchi algorithm only repeats the loop (log x) 2 times (e.g., while (count <(log x)²), and then falls back to the standard algorithm, which comprises selecting random odd integers (e.g., random number % 2=1) and testing the random odd integer for primality.

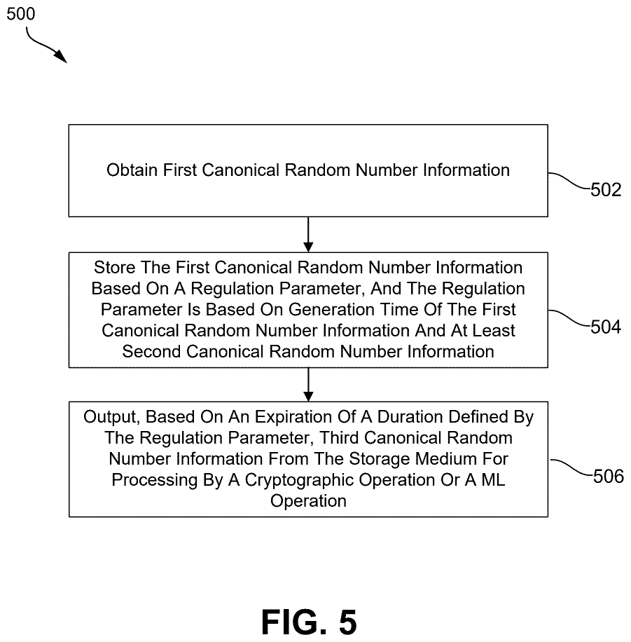

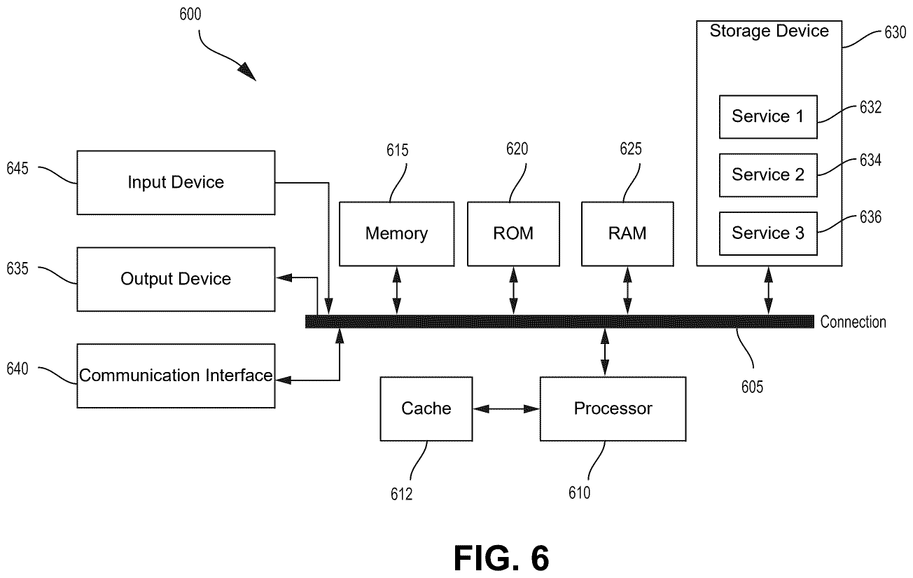

FIG. 5 is a flow diagram illustrating a process 500 for performing wireless communications. The process 500 can be performed by a computing device or by a component or system (e.g., a chipset, one or more processors, etc.) of the wireless device. In some cases, the computing device (or component or system thereof) may include the canonical random number generation system 300 of FIG. 3. The computing device may be a mobile device (e.g., a mobile phone), a network-connected wearable such as a watch, an extended reality (XR) device such as a virtual reality (VR) device or augmented reality (AR) device, a vehicle or component or system of a vehicle, or other type of computing device. The operations of the process 500 may be implemented as software components that are executed and run on one or more processors (e.g., the processor 102 of the computing device 100 of FIG. 1, and/or other processor(s)). Further, the transmission and reception of signals by the computing device may be enabled, for example, by one or more antennas and/or one or more transceivers (e.g., the communication interface 640 of FIG. 6, etc.).

At block 502, the computing device (or component thereof) may obtain first canonical random number information. For example, the computing device (or component thereof, such as the RNG 302 of the RNG 302 of FIG. 3) may generate random information based on an available amount of entropy within the hardware of the computing device and determine that the random information corresponds to canonical random number information (e.g., a random strong prime, a random quadratic residue, a random invertible matrix, etc.).

In one aspect, the first canonical random number information is a first prime number, the second canonical random number information is a second prime number, and the third canonical random number information is a third prime number. In some cases, the first prime number, the second prime number, and the third prime number may be strong prime numbers. In another aspect, the first canonical random number information includes a first quadratic residue, the second canonical random number information includes a second quadratic residue, and the third canonical random number information includes a third quadratic residue. In some other aspects, the first canonical random number information includes a first random invertible matrix, the second canonical random number information includes a second random invertible matrix, and the third canonical random number information includes a third random invertible matrix. In some cases, the third canonical random number information includes the first canonical random number information.

At block 504, the computing device (or component thereof) may store the first canonical random number information in a storage medium of a device (e.g., the store 308 of the RNG 302 of FIG. 3) based on a regulation parameter (e.g., the threshold u described herein). The regulation parameter is based on a generation time of the first canonical random number information and at least second canonical random number information that is immediately before the first canonical random number information. For example, the first canonical random number information and the second canonical random number information may be consecutive and there may be no intervening random numbers (between the first canonical random number information and the second canonical random number) that can be deemed canonical random number information. In some aspects, the regulation parameter (e.g., the threshold u) can be based on a generation time of canonical random number information. For instance, the regulation parameter (e.g., the threshold u) may be in units of a number of cycles (e.g., 10⁴ cycles of a clock of a device include the canonical random number generation system 300, 700 ms, etc.), may be in units of time, or any other similar unit. In one illustrative example, the regulation parameter is a minimum delay between two consecutive canonical random numbers. For example, the regulation parameter can be 700 milliseconds (ms) in some cases.

In some aspects, the regulation parameter is based on a storage threshold (e.g., the threshold u) associated with a stored quantity of canonical random number information stored in the storage medium. For example, the computing device (or component thereof) may determine that a stored quantity of canonical random number information stored in the storage medium (e.g., the store 308) is greater than a storage threshold. The computing device (or component thereof) may decrease a value of the regulation parameter based on the stored quantity of canonical number information being greater than the storage threshold. In another example, the computing device (or component thereof) may determine that a stored quantity of canonical random number information stored in the storage medium is less than a storage threshold and increase a value of the regulation parameter based on the stored quantity of canonical number information being less than the storage threshold.

In some cases, the regulation parameter may be fixed (with a fixed value) or may be dynamic (with dynamically changing values). In some cases, the storage threshold is associated with a certain amount of a total capacity (e.g., a median capacity, such as half capacity) of a data structure (e.g., a stack, a queue, a linked list, etc.) used for storing canonical random number information in the storage medium. In one illustrative example, the data structure of the storage medium may be a stack having a maximum length of 1,024 32-bit values, and the storage threshold may be half (e.g., a median) of the maximum length (e.g., 512).

The computing device (or component thereof) may determine that a duration defined by the regulation parameter has expired. For example, a timer may expire. A speed of a clock of the device may be equal to an average time for canonical random number generation by a canonical random number generator.

At block 506, the computing device (or component thereof) may output, based on an expiration of a duration defined by the regulation parameter, third canonical random number information from the storage medium for processing by a cryptographic operation or a machine learning operation. In some aspects, the third canonical random number information is stored in a data structure (e.g., a stack, a queue, a linked list, etc.) used for storing canonical random number information in the storage medium. In some aspects, a random prime number is expected on an average schedule that can be determined at design time, but is not output due to the high standard deviation associated with canonical random number information. The third canonical random number information fills in for the missing canonical random number information. The third canonical random number information may be generated before the first random number information when the canonical random number generator was producing too many random canonical numbers. For example, the third canonical random number information is generated before (and thus precedes) the first canonical random number information in time.

In some aspects, the cryptographic operation may include an encryption. For example, the computing device (or component thereof) may encrypt information based on the third canonical random number information. In some aspects, an application may request canonical random number information in connection with generating encryption keys for configuring a secure communication channel.

FIG. 6 is a diagram illustrating an example of a system for implementing certain aspects of the present technology. In particular, FIG. 6 illustrates an example of computing system 600, which may be for example any computing device making up internal computing system, a remote computing system, a camera, or any component thereof in which the components of the system are in communication with each other using connection 605. Connection 605 may be a physical connection using a bus, or a direct connection into processor 610, such as in a chipset architecture. Connection 605 may also be a virtual connection, networked connection, or logical connection.

In some embodiments, computing system 600 is a distributed system in which the functions described in this disclosure may be distributed within a datacenter, multiple data centers, a peer network, etc. In some embodiments, one or more of the described system components represents many such components each performing some or all of the function for which the component is described. In some embodiments, the components may be physical or virtual devices.

Example system 600 includes at least one processing unit (CPU or processor) 610 and connection 605 that communicatively couples various system components including system memory 615, such as read-only memory (ROM) 620 and random access memory (RAM) 625 to processor 610. Computing system 600 may include a cache 612 of high-speed memory connected directly with, in close proximity to, or integrated as part of processor 610.

Processor 610 may include any general purpose processor and a hardware service or software service, such as services 632, 634, and 636 stored in storage device 630, configured to control processor 610 as well as a special-purpose processor where software instructions are incorporated into the actual processor design. Processor 610 may essentially be a completely self-contained computing system, containing multiple cores or processors, a bus, memory controller, cache, etc. A multi-core processor may be symmetric or asymmetric.

To enable user interaction, computing system 600 includes an input device 645, which may represent any number of input mechanisms, such as a microphone for speech, a touch-sensitive screen for gesture or graphical input, keyboard, mouse, motion input, speech, etc. Computing system 600 may also include output device 635, which may be one or more of a number of output mechanisms. In some instances, multimodal systems may enable a user to provide multiple types of input/output to communicate with computing system 600.

Computing system 600 may include communication interface 640, which may generally govern and manage the user input and system output. The communication interface may perform or facilitate receipt and/or transmission wired or wireless communications using wired and/or wireless transceivers, including those making use of an audio jack/plug, a microphone jack/plug, a universal serial bus (USB) port/plug, an Apple™ Lightning™ port/plug, an Ethernet port/plug, a fiber optic port/plug, a proprietary wired port/plug, 3G, 4G, 5G and/or other cellular data network wireless signal transfer, a Bluetooth™ wireless signal transfer, a Bluetooth™ low energy (BLE) wireless signal transfer, an IBEACON™ wireless signal transfer, a radio-frequency identification (RFID) wireless signal transfer, near-field communications (NFC) wireless signal transfer, dedicated short range communication (DSRC) wireless signal transfer, 802.11 Wi-Fi wireless signal transfer, wireless local area network (WLAN) signal transfer, Visible Light Communication (VLC), Worldwide Interoperability for Microwave Access (WiMAX), Infrared (IR) communication wireless signal transfer, Public Switched Telephone Network (PSTN) signal transfer, Integrated Services Digital Network (ISDN) signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof. The communication interface 640 may also include one or more Global Navigation Satellite System (GNSS) receivers or transceivers that are used to determine a location of the computing system 600 based on receipt of one or more signals from one or more satellites associated with one or more GNSS systems. GNSS systems include, but are not limited to, the US-based Global Positioning System (GPS), the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 630 may be a non-volatile and/or non-transitory and/or computer-readable memory device and may be a hard disk or other types of computer readable media which may store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a blu-ray disc (BDD) optical disc, a holographic optical disk, another optical medium, a secure digital (SD) card, a micro secure digital (microSD) card, a Memory Stick® card, a smartcard chip, a EMV chip, a subscriber identity module (SIM) card, a mini/micro/nano/pico SIM card, another integrated circuit (IC) chip/card, random access memory (RAM), static RAM (SRAM), dynamic RAM (DRAM), read-only memory (ROM), programmable read-only memory (PROM), erasable programmable read-only memory (EPROM), electrically erasable programmable read-only memory (EEPROM), flash EPROM (FLASHEPROM), cache memory (e.g., Level 1 (L1) cache, Level 2 (L2) cache, Level 3 (L3) cache, Level 4 (L4) cache, Level 5 (L5) cache, or other (L #) cache), resistive random-access memory (RRAM/ReRAM), phase change memory (PCM), spin transfer torque RAM (STT-RAM), another memory chip or cartridge, and/or a combination thereof.

The storage device 630 may include software services, servers, services, etc., that when the code that defines such software is executed by the processor 610, it causes the system to perform a function. In some embodiments, a hardware service that performs a particular function may include the software component stored in a computer-readable medium in connection with the necessary hardware components, such as processor 610, connection 605, output device 635, etc., to carry out the function. The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data may be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

Specific details are provided in the description above to provide a thorough understanding of the embodiments and examples provided herein, but those skilled in the art will recognize that the application is not limited thereto. Thus, while illustrative embodiments of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, embodiments may be utilized in any number of environments and applications beyond those described herein without departing from the broader scope of the specification. The specification and drawings are, accordingly, to be regarded as illustrative rather than restrictive. For the purposes of illustration, methods were described in a particular order. It should be appreciated that in alternate embodiments, the methods may be performed in a different order than that described.

For clarity of explanation, in some instances the present technology may be presented as including individual functional blocks including devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

Individual embodiments may be described above as a process or method which is depicted as a flowchart, a flow diagram, a data flow diagram, a structure diagram, or a block diagram. Although a flowchart may describe the operations as a sequential process, many of the operations may be performed in parallel or concurrently. In addition, the order of the operations may be re-arranged. A process is terminated when its operations are completed but could have additional steps not included in a figure. A process may correspond to a method, a function, a procedure, a subroutine, a subprogram, etc. When a process corresponds to a function, its termination may correspond to a return of the function to the calling function or the main function.

Processes and methods according to the above-described examples may be implemented using computer-executable instructions that are stored or otherwise available from computer-readable media. Such instructions may include, for example, instructions and data which cause or otherwise configure a general purpose computer, special purpose computer, or a processing device to perform a certain function or group of functions. Portions of computer resources used may be accessible over a network. The computer executable instructions may be, for example, binaries, intermediate format instructions such as assembly language, firmware, source code. Examples of computer-readable media that may be used to store instructions, information used, and/or information created during methods according to described examples include magnetic or optical disks, flash memory, USB devices provided with non-volatile memory, networked storage devices, and so on.

In some embodiments the computer-readable storage devices, mediums, and memories may include a cable or wireless signal containing a bitstream and the like. However, when mentioned, non-transitory computer-readable storage media expressly exclude media such as energy, carrier signals, electromagnetic waves, and signals per se.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof, in some cases depending in part on the particular application, in part on the desired design, in part on the corresponding technology, etc.

The various illustrative logical blocks, modules, and circuits described in connection with the aspects disclosed herein may be implemented or performed using hardware, software, firmware, middleware, microcode, hardware description languages, or any combination thereof, and may take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Examples of form factors include laptops, smart phones, mobile phones, tablet devices or other small form factor personal computers, personal digital assistants, rackmount devices, standalone devices, and so on. Functionality described herein also may be embodied in peripherals or add-in cards. Such functionality may also be implemented on a circuit board among different chips or different processes executing in a single device, by way of further example.

The instructions, media for conveying such instructions, computing resources for executing them, and other structures for supporting such computing resources are example means for providing the functions described in the disclosure.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium including program code including instructions that, when executed, performs one or more of the methods, algorithms, and/or operations described above. The computer-readable data storage medium may form part of a computer program product, which may include packaging materials. The computer-readable medium may include memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that may be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general-purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

One of ordinary skill will appreciate that the less than (“<”) and greater than (“>”) symbols or terminology used herein may be replaced with less than or equal to (“≤”) and greater than or equal to (“≥”) symbols, respectively, without departing from the scope of this description.

Where components are described as being “configured to” perform certain operations, such configuration may be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” or “communicatively coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, A and B and C, or any duplicate information or data (e.g., A and A, B and B, C and C, A and A and B, and so on), or any other ordering, duplication, or combination of A, B, and C. The language “at least one of” a set and/or “one or more” of a set does not limit the set to the items listed in the set. For example, claim language reciting “at least one of A and B” or “at least one of A or B” may mean A, B, or A and B, and may additionally include items not listed in the set of A and B. The phrases “at least one” and “one or more” are used interchangeably herein.

Claim language or other language reciting “at least one processor configured to,” “at least one processor being configured to,” “one or more processors configured to,” “one or more processors being configured to,” or the like indicates that one processor or multiple processors (in any combination) can perform the associated operation(s). For example, claim language reciting “at least one processor configured to: X, Y, and Z” means a single processor can be used to perform operations X, Y, and Z; or that multiple processors are each tasked with a certain subset of operations X, Y, and Z such that together the multiple processors perform X, Y, and Z; or that a group of multiple processors work together to perform operations X, Y, and Z. In another example, claim language reciting “at least one processor configured to: X, Y, and Z” can mean that any single processor may only perform at least a subset of operations X, Y, and Z.

Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions.

Where reference is made to an entity (e.g., any entity or device described herein) performing functions or being configured to perform functions (e.g., steps of a method), the entity may be configured to cause one or more elements (individually or collectively) to perform the functions. The one or more components of the entity may include at least one memory, at least one processor, at least one communication interface, another component configured to perform one or more (or all) of the functions, and/or any combination thereof. Where reference to the entity performing functions, the entity may be configured to cause one component to perform all functions, or to cause more than one component to collectively perform the functions. When the entity is configured to cause more than one component to collectively perform the functions, each function need not be performed by each of those components (e.g., different functions may be performed by different components) and/or each function need not be performed in whole by only one component (e.g., different components may perform different sub-functions of a function).

### Illustrative Aspects of the Disclosure Include:

Aspect 1. A method for generating canonical random number information, comprising: obtaining first canonical random number information; storing the first canonical random number information in a storage medium of a device based on a regulation parameter, wherein the regulation parameter is based on a generation time of the first canonical random number information and at least second canonical random number information preceding the first canonical random number information; and outputting, based on an expiration of a duration defined by the regulation parameter, third canonical random number information from the storage medium for processing by a cryptographic operation or a machine learning operation.

Aspect 2. The method of Aspect 1, wherein the third canonical random number information comprises canonical random number information preceding the first canonical random number information.

Aspect 3. The method of any of Aspects 1 to 2, wherein the regulation parameter is further based on a storage threshold associated with a stored quantity of canonical random number information stored in the storage medium.

Aspect 4. The method of any of Aspects 1 to 3, further comprising: determining a stored quantity of canonical random number information stored in the storage medium is greater than the storage threshold; and decreasing a value of the regulation parameter based on the stored quantity of canonical number information being greater than the storage threshold.

Aspect 5. The method of Aspect 4, further comprising: determining a stored quantity of canonical random number information stored in the storage medium is less than the storage threshold; and increasing a value of the regulation parameter based on the stored quantity of canonical number information being less than the storage threshold.

Aspect 6. The method of any of Aspects 4 or 5, wherein the storage threshold is associated with a median of a total capacity of a data structure used for storing canonical random number information in the storage medium.

Aspect 7. The method of any of Aspects 4 to 6, wherein the regulation parameter has a fixed value.

Aspect 8. The method of any of Aspects 1 to 7, wherein the first canonical random number information is a first prime number, the second canonical random number information is a second prime number, and the third canonical random number information is a third prime number.

Aspect 9. The method of Aspect 8, wherein the first prime number, the second prime number, and the third prime number are strong prime numbers.

Aspect 10. The method of any of Aspects 1 to 9, wherein the first canonical random number information comprises a first quadratic residue, the second canonical random number information comprises a second quadratic residue, and the third canonical random number information comprises a third quadratic residue.

Aspect 11. The method of any of Aspects 1 to 10, wherein the first canonical random number information comprises a first random invertible matrix, the second canonical random number information comprises a second random invertible matrix, and the third canonical random number information comprises a third random invertible matrix.

Aspect 12. The method of any of Aspects 1 to 11, wherein the third canonical random number information comprises the first canonical random number information.

Aspect 13. The method of any of Aspects 1 to 12, wherein the cryptographic operation comprises encryption, the method further comprising: encrypting information based on the third canonical random number information.

Aspect 14. The method of any of Aspects 1 to 13, wherein the third canonical random number information is provided in response to a request.

Aspect 15. The method of any of Aspects 1 to 14, wherein a speed of a clock of the device is equal to an average time for canonical random number generation by a canonical random number generator.

Aspect 16. An apparatus for generating canonical random number information. The apparatus includes a memory and a processor coupled to the memory. The processor is configured to: obtain first canonical random number information; store the first canonical random number information in a storage medium of a device based on a regulation parameter, wherein the regulation parameter is based on a generation time of the first canonical random number information and at least second canonical random number information preceding the first canonical random number information; and output, based on an expiration of a duration defined by the regulation parameter, third canonical random number information from the storage medium for processing by a cryptographic operation or a machine learning operation.

Aspect 17. The apparatus of Aspect 16, wherein the third canonical random number information comprises canonical random number information preceding the first canonical random number information.

Aspect 18. The apparatus of any of Aspects 16 to 17, wherein the regulation parameter is further based on a storage threshold associated with a stored quantity of canonical random number information stored in the storage medium.

Aspect 19. The apparatus of Aspects 18, wherein the processor is configured to: determine a stored quantity of canonical random number information stored in the storage medium is greater than the storage threshold; and decrease a value of the regulation parameter based on the stored quantity of canonical number information being greater than the storage threshold.

Aspect 20. The apparatus of any of Aspects 18 or 19, wherein the processor is configured to: determine a stored quantity of canonical random number information stored in the storage medium is less than the storage threshold; and increase a value of the regulation parameter based on the stored quantity of canonical number information being less than the storage threshold.

Aspect 21. The apparatus of any of Aspects 18 to 20, wherein the storage threshold is associated with a median of a total capacity of a data structure used for storing canonical random number information in the storage medium.

Aspect 22. The apparatus of any of Aspects 16 to 21, wherein the regulation parameter has a fixed value.

Aspect 23. The apparatus of any of Aspects 16 to 22, wherein the first canonical random number information is a first prime number, the second canonical random number information is a second prime number, and the third canonical random number information is a third prime number.

Aspect 24. The apparatus of Aspect 23, wherein the first prime number, the second prime number, and the third prime number are strong prime numbers.

Aspect 25. The apparatus of any of Aspects 16 to 24, wherein the first canonical random number information comprises a first quadratic residue, the second canonical random number information comprises a second quadratic residue, and the third canonical random number information comprises a third quadratic residue.

Aspect 26. The apparatus of any of Aspects 16 to 25, wherein the first canonical random number information comprises a first random invertible matrix, the second canonical random number information comprises a second random invertible matrix, and the third canonical random number information comprises a third random invertible matrix.

Aspect 27. The apparatus of any of Aspects 16 to 26, wherein the third canonical random number information comprises the first canonical random number information.

Aspect 28. The apparatus of any of Aspects 16 to 27, wherein the cryptographic operation comprises encryption, and wherein the processor is configured to encrypt information based on the third canonical random number information.

Aspect 29. The apparatus of any of Aspects 16 to 28, wherein the third canonical random number information is provided in response to a request.

Aspect 30. The apparatus of any of Aspects 16 to 29, wherein a speed of a clock of the device is equal to an average time for canonical random number generation by a canonical random number generator.

Aspect 31. A non-transitory computer-readable storage medium comprising instructions stored thereon which, when executed by a processor, causes the processor to perform operations according to any of Aspects 1 to 15.

Aspect 32. An apparatus for generating canonical random number information comprising one or more means for performing operations according to any of Aspects 1 to 15.

What is claimed is:

1. A method for generating canonical random number information, comprising:
obtaining first canonical random number information;
storing the first canonical random number information in a storage medium of a device based on a regulation parameter, wherein the regulation parameter is based on a generation time of the first canonical random number information and at least second canonical random number information preceding the first canonical random number information; and
outputting, based on an expiration of a duration defined by the regulation parameter, third canonical random number information from the storage medium for processing by a cryptographic operation or a machine learning operation.

2. The method of claim 1, wherein the third canonical random number information comprises canonical random number information preceding the first canonical random number information.

3. The method of claim 1, wherein the regulation parameter is further based on a storage threshold associated with a stored quantity of canonical random number information stored in the storage medium.

4. The method of claim 3, further comprising:
determining a quantity of canonical random number information stored in the storage medium is greater than the storage threshold; and
decreasing a value of the regulation parameter based on the stored quantity of canonical random number information being greater than the storage threshold.

5. The method of claim 3, further comprising:
determining a stored quantity of canonical random number information stored in the storage medium is less than the storage threshold; and
increasing a value of the regulation parameter based on the stored quantity of canonical random number information being less than the storage threshold.

6. The method of claim 3, wherein the storage threshold is associated with a median of a total capacity of a data structure used for storing canonical random number information in the storage medium.

7. The method of claim 1, wherein the regulation parameter has a fixed value.

8. The method of claim 1, wherein the first canonical random number information is a first prime number, the second canonical random number information is a second prime number, and the third canonical random number information is a third prime number.

9. The method of claim 8, wherein the first prime number, the second prime number, and the third prime number are strong prime numbers.

10. The method of claim 1, wherein the first canonical random number information comprises a first quadratic residue, the second canonical random number information comprises a second quadratic residue, and the third canonical random number information comprises a third quadratic residue.

11. The method of claim 1, wherein the first canonical random number information comprises a first random invertible matrix, the second canonical random number information comprises a second random invertible matrix, and the third canonical random number information comprises a third random invertible matrix.

12. The method of claim 1, wherein the third canonical random number information comprises the first canonical random number information.

13. The method of claim 1, wherein the cryptographic operation comprises encryption, the method further comprising:
encrypting information based on the third canonical random number information.

14. The method of claim 1, wherein the third canonical random number information is provided in response to a request.

15. The method of claim 1, wherein a speed of a clock of the device is equal to an average time for canonical random number generation by a canonical random number generator.

16. An apparatus for generating canonical random number information, comprising:
a memory; and
a processor coupled to the memory and configured to:
obtain first canonical random number information;
store the first canonical random number information in a storage medium of a device based on a regulation parameter, wherein the regulation parameter is based on a generation time of the first canonical random number information and at least second canonical random number information preceding the first canonical random number information; and
output, based on an expiration of a duration defined by the regulation parameter, third canonical random number information from the storage medium for processing by a cryptographic operation or a machine learning operation.

17. The apparatus of claim 16, wherein the third canonical random number information comprises canonical random number information preceding the first canonical random number information.

18. The apparatus of claim 16, wherein the regulation parameter is further based on a storage threshold associated with a stored quantity of canonical random number information stored in the storage medium.

19. The apparatus of claim 18, wherein the processor is configured to:
determine a stored quantity of canonical random number information stored in the storage medium is greater than the storage threshold; and
decrease a value of the regulation parameter based on the stored quantity of canonical random number information being greater than the storage threshold.

20. The apparatus of claim 18, wherein the processor is configured to:
determine a stored quantity of canonical random number information stored in the storage medium is less than the storage threshold; and
increase a value of the regulation parameter based on the stored quantity of canonical random number information being less than the storage threshold.

21. The apparatus of claim 18, wherein the storage threshold is associated with a median of a total capacity of a data structure used for storing canonical random number information in the storage medium.

22. The apparatus of claim 16, wherein the regulation parameter has a fixed value.

23. The apparatus of claim 16, wherein the first canonical random number information is a first prime number, the second canonical random number information is a second prime number, and the third canonical random number information is a third prime number.

24. The apparatus of claim 23, wherein the first prime number, the second prime number, and the third prime number are strong prime numbers.

25. The apparatus of claim 16, wherein the first canonical random number information comprises a first quadratic residue, the second canonical random number information comprises a second quadratic residue, and the third canonical random number information comprises a third quadratic residue.

26. The apparatus of claim 16, wherein the first canonical random number information comprises a first random invertible matrix, the second canonical random number information comprises a second random invertible matrix, and the third canonical random number information comprises a third random invertible matrix.

27. The apparatus of claim 16, wherein the third canonical random number information comprises the first canonical random number information.

28. The apparatus of claim 16, wherein the cryptographic operation comprises encryption, and wherein the processor is configured to:
encrypt information based on the third canonical random number information.

29. The apparatus of claim 16, wherein the third canonical random number information is provided in response to a request.

30. The apparatus of claim 16, wherein a speed of a clock of the device is equal to an average time for canonical random number generation by a canonical random number generator.
